(19) United States
(12) Patent Application Publication
(10) Pub. No.: US 2004/0069216 A1
(43) Pub. Date: Apr. 15, 2004

(54) Tilting pickup head

(76) Inventors: Mohan R. Nagar, Milpitas, CA (US); Mukul A. Joshi, Santa Clara, CA (US)

Correspondence Address: LSI LOGIC CORPORATION, 1621 BARBER LANE, MS: D-106 LEGAL, MILPITAS, CA, 95035, US

(21) Appl. No.: 10/270,956

(22) Filed: Oct. 15, 2002

(51) Int. Cl. B05C 3/00

(52) U.S. Cl. 118/74; 118/423

(57) ABSTRACT

A pickup head for engaging an integrated circuit from a first side. The pickup head can dip solder bumps disposed on an opposing second side of the integrated circuit into a layer of flux on a flat surface in a uniform manner. An arm attaches the pickup head to a mobility unit, and a retainer selectively retains the first side of the integrated circuit against the pickup head. A pivot is disposed between the arm and the retainer, and enables the retainer to pivot and the integrated circuit to freely align with the flat surface in such a manner that as many of the solder bumps as possible are in contact with the flat surface, regardless of variations in heights of the solder bumps. The solder bumps are thereby more uniformly coated with flux.

### FIELD

This invention relates to the field of integrated circuit fabrication. More particularly, this invention relates to integrated circuit packaging.

### BACKGROUND

Integrated circuits are preferably packaged prior to use in a larger circuit, so as to protect the integrated circuit and provide for electrical interconnections with other parts of the larger circuit that are more easily made. Different types of packaging are used for different types of integrated circuits. For example, one type of integrated circuit is classified as a flip chip. Flip chips are distinguishable from other types of integrated circuits in that the electrical contacts for the integrated circuit, or bonding pads, are typically distributed across the entire top surface of the integrated circuit, rather than being limited to a few rows around the peripheral edge of the integrated circuit, as is done with some other integrated circuit types.

Flip chip integrated circuits are typically packaged by attaching small pieces of solder, called solder bumps, to the bonding pads of the integrated circuit. The solder bumps are then fluxed and the integrated circuit is attached to a package substrate by reflowing the solder bumps onto electrical connections on the package substrate. The mounted flip chip is then under filled with a material to enhance the structural strength of the integrated circuit and package substrate combination. Finally, the integrated circuit is encapsulated against the package substrate, such as with a potting compound or a lid structure. Electrical connections to an outside circuit are then made through the package substrate, which reduces the concern that the integrated circuit may be damaged, such as by further handling.

Although the packaging process results in a packaged integrated circuit that is generally more robust than the unprotected die, the packaging process itself may result in problems that tend to damage or otherwise effect the reliability of the integrated circuit. For example, problems in the fluxing process may result in integrated circuits that are inadequately bonded to the package substrate, and which therefore experience electrical failures, either immediately or prematurely.

The flux is typically applied to the integrated circuit by dipping the solder bumps in a layer of flux that is spread across a flat surface. The integrated circuit is held from behind, such as by a vacuum pickup head, and the solder bump side of the integrated circuit is brought into position against the layer of flux on the flat surface, thus transferring some of the flux from the flat surface to the solder bumps. The vacuum pickup head is typically rigidly aligned so as to be parallel with the flux plate, so that the solder bumps might be uniformly covered with solder.

Unfortunately, the solder bumps tend to not all be of uniform size. Thus, because of the thickness variations in the solder bumps, some solder bumps receive a relatively greater amount of flux, and some solder bumps receive a relatively lesser amount of flux, and some solder bumps may receive no flux whatsoever. This condition occurs when the fixed pickup head brings the integrated circuit down against the flat surface, and the descent of the pickup head is halted because the thicker ones of the solder bumps hit the flat surface. Thus, some of the thinner solder bumps may not even extend into the solder on the flat surface to any degree at all.

What is needed, therefore, is a system by which solder bumps of non uniform size are more evenly coated with flux in a dipping process.

### SUMMARY

The above and other needs are met by a pickup head for engaging an integrated circuit from a first side. The pickup head can dip solder bumps disposed on an opposing second side of the integrated circuit into a layer of flux on a flat surface in a uniform manner. An arm attaches the pickup head to a mobility unit, and a retainer selectively retains the first side of the integrated circuit against the pickup head. A pivot is disposed between the arm and the retainer, and enables the retainer to pivot and the integrated circuit to freely align with the flat surface in such a manner that as many of the solder bumps as possible are in contact with the flat surface, regardless of variations in heights of the solder bumps. The solder bumps are thereby more uniformly coated with flux.

In this manner, the pickup head does not keep the integrated circuit in a rigid and inflexible alignment with the flat surface on which the flux is layered. Thus, when the solder bumps on the integrated circuit are brought into contact with the flux and the flat surface, the pivot allows the pickup head to freely align to the flat surface, dependent at least in part upon the various thicknesses of the solder bumps, and a greater number of the solder bumps are thereby permitted to come into contact with the layer of flux on the flat surface. Thus, a more uniform coating of flux is applied to the solder bumps, and the subsequent soldering process of the integrated circuit to the package substrate is more reliably accomplished.

In various preferred embodiments, the retainer is a vacuum head that selectively applies a vacuum against the first side of the integrated circuit, and thereby selectively retains the integrated circuit against the pickup head. The pivot preferably enables at least partial rotation of the retainer with respect to the arm in at least two axes. In one embodiment the pivot comprises a pin retaining the arm to the retainer, where the pin enables at least partial rotation of the retainer with respect to the arm in at least one axis. Most preferably the pivot is a ball and socket joint retaining the arm to the retainer, where the ball and socket joint enables at least partial rotation of the retainer with respect to the arm in at least two axes.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a cross sectional view of the solder bumps on an integrated circuit that are brought into contact with flux on a flat surface, where the orientation of the integrated circuit in regard to the flat surface is rigid and fixed,

FIG. 2 is a cross sectional view of the solder bumps on an integrated circuit that are brought into contact with flux on a flat surface, where the orientation of the integrated circuit in regard to the flat surface is variable about a pivoting member with a pin, and

FIG. 3 is a cross sectional view of the solder bumps on an integrated circuit that are brought into contact with flux on a flat surface, where the orientation of the integrated circuit in regard to the flat surface is variable about a pivoting member with a ball and socket.

### DETAILED DESCRIPTION

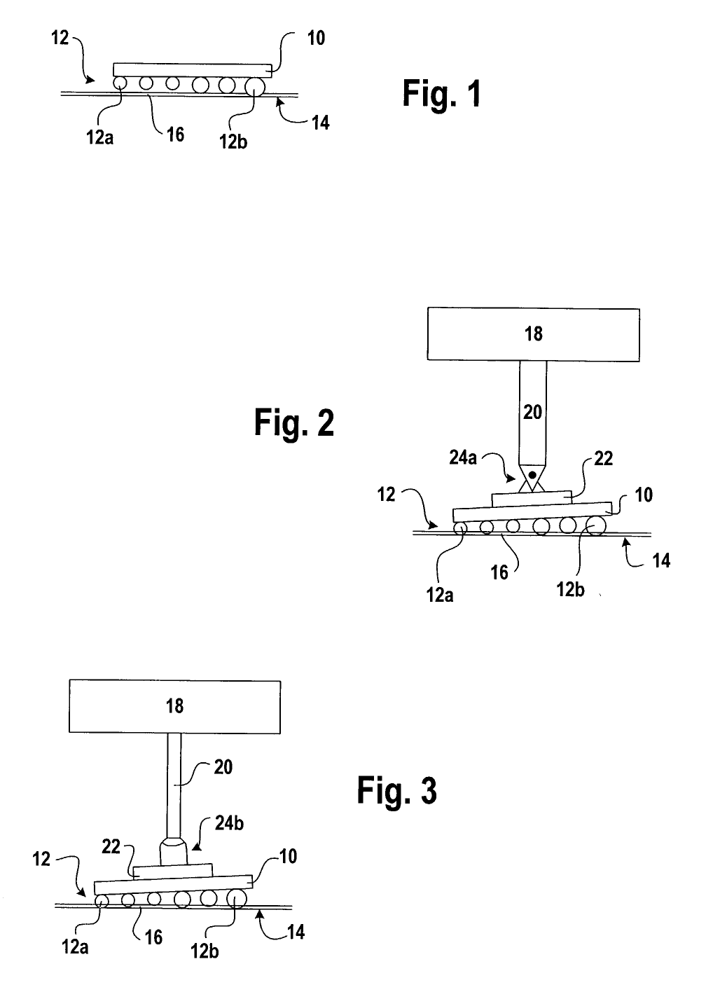

With reference now to FIG. 1 there is depicted a cross sectional view of the solder bumps 12 on an integrated circuit 10 that are brought into contact with flux 16 on a flat surface 14, such as the flux plate of a fluxer, where the orientation of the integrated circuit 10 in regard to the flat surface 14 is rigid and fixed. As depicted in FIG. 1, this rigid alignment causes some of the smaller solder bumps, such as 12a, to not dip into the flux 16, because the larger solder bumps, such as 12b, hit against the flat surface 14 before the smaller solder bumps 12 are dipped into the flux layer 16. Thus, when the pickup head maintains a rigid alignment or orientation between the integrated circuit 10 and the flat surface 14, there is a possibility that some of the solder bumps 12 are not properly fluxed.

With reference now to FIG. 2, there is depicted a cross sectional view of the solder bumps 12 on an integrated circuit 10 that are brought into contact with flux 16 on a flat surface 14, where the orientation of the integrated circuit 10 in regard to the flat surface 14 is variable about a pivoting member 24a. The pivoting member 24a is disposed between an arm 20, which is connected to a mobility unit 18, which enables movement of the integrated circuit 10, such as may be provided by equipment commonly referred to as a pick and place. The pivoting member 24a connects the arm 20 to a retainer 22, which selectively retains the integrated circuit 10. The combination of the arm 30, pivot 24a, and the retainer 22 is referred to herein as a pickup head.

The pivoting member 24a enables the retainer 22 to pivot and the integrated circuit 10 to freely align with the flat surface 14 in such a manner that as many of the solder bumps 12 as possible are in contact with the flat surface 14, regardless of variations in heights of the solder bumps 12, and the solder bumps 12 are thereby more uniformly coated with flux 16. As can be seen in FIG. 2, with this arrangement, the smaller solder bumps such as 12a are thereby able to be coated with flux 16, because they can tip toward the flat surface 14, as enabled by the pivot 24a.

As depicted in FIG. 2, the pivot 24a is a pin between the arm 20 and the retainer 22, which enables at least partial rotation of the retainer 22 with respect to the arm 20 in at least one axis. FIG. 3 depicts another embodiment, wherein the pivot 24b is a ball and socket, which enables at least partial rotation of the retainer 22 with respect to the arm 20 in at least two axes. Thus, the ball and socket 24b provides even greater benefits than the pin 24a, as the ball and socket 24b allow for an even greater freedom of movement of the retainer 22 with respect to the arm 20, which allows for a freer repositioning of the solder bumps 12 across the entire bottom surface of the integrated circuit 10. It is appreciated that other configurations for a pivot 24a or 24b are also within the scope of the present invention, which is not limited to the two specific cases of a pin 24a and a ball and socket 24b.

The retainer 22 preferably engages a top surface of the integrated circuit 10, so that the bottom surface of the integrated circuit 10, where the solder bumps 12 are disposed, can be dipped into the solder 16. In a most preferred embodiment, the retainer 22 is a vacuum head that selectively applies a vacuum against the top surface of the integrated circuit 10, and thereby selectively retains the integrated circuit 10 against the pickup head. In alternate embodiments the retainer 22 may be a lightly adhesive member, which retains the integrated circuit 10 until a greater force breaks the adhesion between the retainer 22 and the integrated circuit 10. Thus, the present invention is not strictly limited to a vacuum type retainer 22.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally, and equitably entitled.

What is claimed is:

1. A pickup head for engaging an integrated circuit from a first side, and dipping solder bumps disposed on an opposing second side of the integrated circuit into a layer of flux on a flat surface in a uniform manner, the pickup head comprising:
an arm for attaching the pickup head to a mobility unit,
a retainer for selectively retaining the first side of the integrated circuit against the pickup head, and
a pivot disposed between the arm and the retainer, for enabling the retainer to pivot and the integrated circuit to freely align with the flat surface in such a manner that as many of the solder bumps as possible are in contact with the flat surface, regardless of variations in heights of the solder bumps, and the solder bumps are thereby more uniformly coated with flux.

2. The pickup head of claim 1, wherein the retainer comprises a vacuum head for selectively applying a vacuum against the first side of the integrated circuit, and thereby selectively retaining the integrated circuit against the pickup head.

3. The pickup head of claim 1, wherein the pivot enables at least partial rotation of the retainer with respect to the arm in at least two axes.

4. The pickup head of claim 1, wherein the pivot comprises a pin retaining the arm to the retainer, the pin enabling at least partial rotation of the retainer with respect to the arm in at least one axis.

5. The pickup head of claim 1, wherein the pivot comprises a ball and socket joint retaining the arm to the retainer, the ball and socket joint enabling at least partial rotation of the retainer with respect to the arm in at least two axes.

6. A pickup head for engaging an integrated circuit from a first side, and dipping solder bumps disposed on an opposing second side of the integrated circuit into a layer of flux on a flat surface in a uniform manner, the pickup head comprising:
an arm for attaching the pickup head to a mobility unit,
a vacuum head for selectively applying a vacuum against the first side of the integrated circuit, and thereby selectively retaining the integrated circuit against the pickup head, and
a pivot disposed between the arm and the vacuum head, for enabling the vacuum head to pivot and the integrated circuit to freely align with the flat surface in such a manner that as many of the solder bumps as possible are in contact with the flat surface, regardless of variations in heights of the solder bumps, and the solder bumps are thereby more uniformly coated with flux.

7. The pickup head of claim 6, wherein the pivot enables at least partial rotation of the retainer with respect to the arm in at least two axes.

8. The pickup head of claim 6, wherein the pivot comprises a pin retaining the arm to the retainer, the pin enabling at least partial rotation of the retainer with respect to the arm in at least one axis.

9. The pickup head of claim 6, wherein the pivot comprises a ball and socket joint retaining the arm to the retainer, the ball and socket joint enabling at least partial rotation of the retainer with respect to the arm in at least two axes.

10. A pickup head for engaging an integrated circuit from a first side, and dipping solder bumps disposed on an opposing second side of the integrated circuit into a layer of flux on a flat surface in a uniform manner, the pickup head comprising:
an arm for attaching the pickup head to a mobility unit,
a retainer for selectively retaining the first side of the integrated circuit against the pickup head, and
a ball and socket joint disposed between the arm and the retainer and enabling at least partial rotation of the retainer with respect to the arm in at least two axes, for enabling the retainer to pivot and the integrated circuit to freely align with the flat surface in such a manner that as many of the solder bumps as possible are in contact with the flat surface, regardless of variations in heights of the solder bumps, and the solder bumps are thereby more uniformly coated with flux.

11. The pickup head of claim 10, wherein the retainer comprises a vacuum head for selectively applying a vacuum against the first side of the integrated circuit, and thereby selectively retaining the integrated circuit against the pickup head.
